(19) United States
(12) Patent Application Publication
(10) Pub. No.: US 2026/0030963 A1
(43) Pub. Date: Jan. 29, 2026

(54) METHOD OF ASSISTING MANAGEMENT OPERATION OF MONEY HANDLING MACHINE AND MONEY HANDLING SYSTEM

(71) Applicant: GLORY LTD., Himeji-shi (JP)

(72) Inventors: Junji MASHIMO, Himeji-shi (JP); Yasushi KIMURA, Himeji-shi (JP); Zhiyun SU, Himeji-shi (JP)

(73) Assignee: GLORY LTD., Himeji-shi (JP)

(21) Appl. No.: 19/274,771

(22) Filed: Jul. 21, 2025

(30) Foreign Application Priority Data
Jul. 23, 2024 (JP) 2024-117833

(51) Int. Cl. G07F 19/00; G06F 3/01; G06F 3/04883; G10L 15/22; H04L 51/02

(52) U.S. Cl. CPC G07F 19/206; G06F 3/017; G06F 3/04883; G07F 19/209; G10L 15/22; H04L 51/02; G10L 2015/223

(57) ABSTRACT

A method of assisting a management operation of a money handling machine includes: receiving, by a computer, an instruction related to management operation for a money handling machine from an operator; performing, by the computer, natural language processing on the received instruction, generating an operation command corresponding to the instruction, and outputting the operation command to the money handling machine; and performing, by the money handling machine, an operation corresponding to the operation command to execute the management operation as instructed by the operator.

### CROSS-REFERENCE TO RELATED APPLICATION

This application claims priority to Japanese Patent Application No. 2024-117833 filed on Jul. 23, 2024, the entire disclosure of which is incorporated herein by reference.

### BACKGROUND

A conventional self-service terminal is an automated teller machine (ATM) or a kiosk, which is a device operated by a customer. A problem with a self-service terminal is that a technician must be dispatched to the self-service terminal each time to resolve various problems. A conventional maintenance method utilizes virtual reality (VR). A first engineer at the self-service terminal and a remote engineer geographically distant from the self-service terminal resolve a problem of the self-service terminal through interaction in a VR room including an object corresponding to the self-service terminal.

### SUMMARY

The technique disclosed herein relates to a method that assists management operation of a money handling machine. The method includes: receiving, by a computer, an instruction related to the management operation for a money handling machine from an operator; performing, by the computer, natural language processing on the received instruction, generating an operation command corresponding to the instruction, and outputting the operation command to the money handling machine; and performing, by the money handling machine, an operation corresponding to the operation command to execute the management operation as instructed by the operator.

### BRIEF DESCRIPTION OF THE DRAWINGS

FIG. 1 shows a money handling system.

FIG. 2 is a block diagram of a money handling machine and a tablet device.

FIG. 3 shows an internal structure of a banknote unit.

FIG. 4 shows a functional block of a server.

FIG. 5 is an example of a chat screen in a case where the operator is an expert.

FIG. 6 is an example of a chat screen in a case where the operator is a beginner.

FIG. 7 is an example in which both an error resolution screen and a chat screen are displayed on a display of the money handling machine.

FIG. 8 is an example in which an error resolution screen is displayed on the display of the money handling machine, and a chat screen is displayed on the tablet device.

FIG. 9 is a flowchart related to processing in the server.

### DETAILED DESCRIPTION OF THE DRAWINGS

The money handling machine including the ATM and the kiosk described above is a machine that handles banknotes or coins. Since the money handling machine stores money and/or dispenses the money stored therein, strict management of the money handling machine is required. The operator of the money handling machine must accurately perform the management operation of the money handling machine. The operator is, for example, a staff member of a branch of a financial institution in which the money handling machine is installed. The operator is also a cash-in-transit (CIT) worker. The CIT worker collects money from the money handling machine or replenishes the money handling machine with money. A mistake in operation of the money handling machine by the operator may lead to a discrepancy, that is, a mismatch of the amount managed by the money handling machine.

A management operation of a conventional money handling machine is executed by an operator operating an operation screen displayed on a display of the money handling machine. It takes a long time for the operator to learn how to perform the management operation. The need for a long time to learn the operation leads to an increase in the management cost of the money handling machine.

The techniques disclosed herein facilitate management operations of a money handling machine.

The technique disclosed herein relates to a method that assists management operation of a money handling machine. The method includes: receiving, by a computer, an instruction related to the management operation for a money handling machine from an operator; performing, by the computer, natural language processing on the received instruction, generating an operation command corresponding to the instruction, and outputting the operation command to the money handling machine; and performing, by the money handling machine, an operation corresponding to the operation command to execute the management operation as instructed by the operator.

The operator provides an instruction related to management operation in natural language. The computer receives the instruction from the operator and performs natural language processing on the received instruction. The computer recognizes the instruction from the operator and generates an operation command corresponding to the instruction. The operation command is an operation command for the money handling machine. The computer outputs the generated operation command to the money handling machine. The money handling machine performs an operation corresponding to the operation command. The management operation instructed by the operator is executed.

Since the operator gives the instruction related to management operation in natural language, mistakes in operation are reduced. The management operation of the money handling machine is accurately executed. The use of natural language also facilitates the execution of management operation. The operator can learn the procedure for executing the management operation in a relatively short time. The burden on the operator is thus reduced.

The computer may generate a response related to the received instruction by executing a chatbot program as the natural language processing, and may output the response to the operator.

The computer can accurately recognize the instruction from the operator by using a chatbot to conduct bidirectional interaction with the operator. The computer can generate an accurate operation command. Mistakes in management operation of the money handling machine are reduced.

The computer may generate the response by using an expression that corresponds to an expression contained in the instruction from the operator.

Since the computer response corresponds to the expression that is used in the instruction from the operator, the operator can accurately understand the computer response. Mistakes in management operation of the money handling machine are reduced.

The computer may, before outputting the operation command, generate a response that includes the content of the operation command and confirms consent by the operator, and may output the response to the operator; and the computer may output the operation command to the money handling machine after receiving consent from the operator.

Since the content of the operation command is presented to the operator before the computer outputs the operation command to the money handling machine, the operator can confirm the content of the operation command. Since the computer outputs the operation command to the money handling machine when consent from the operator is obtained, output of an operation command based on a mistake in operation is suppressed.

The computer may obtain information on the operator based on authentication of the operator, and may execute the chatbot program based on the information on the operator.

If information on the operator is stored in advance, the computer can determine whether the operator is an expert or a beginner through authentication of the operator. By having the computer execute the chatbot program based on the information on the operator, the computer can provide appropriate interaction regarding the management operation to each of an expert and a beginner.

The computer may generate a response according to an operation level of the operator.

The operation level herein relates to an ability to execute the management operation, and the operation level of an expert is relatively high, whereas the operation level of a beginner is relatively low. Since the response of the chatbot changes according to the operation level of the operator, both an expert and beginner can smoothly and accurately execute the management operation.

The computer may output, to the operator, a response that prompts the operator to provide information that is insufficient for generating the operation command.

In particular, the instruction of a beginner may lack information necessary for generating the operation command. If there is missing information for generating the operation command, the computer will respond by prompting the operator to provide the missing information. When the operator responds to the response, the missing information is added. The computer may continue to interact with the operator until there is no missing information. The computer can generate an operation command that matches the intention of the operator.

The money handling machine may display, on a display, a screen related to the management operation and a chat screen accompanying the execution of the chatbot program.

The operator can execute the management operation while viewing both the screen related to the management operation and the chat screen. Further, since both the management operation-related screen and the chat screen are displayed on a single display, the wording on the screen can be copied and pasted into the chat screen. This improves the operability of the operator.

The money handling machine may display, on a display, a screen related to the management operation, and a tablet device may display the chat screen accompanying the execution of the chatbot program.

The operator can execute the management operation while viewing both the display of the money handling machine and the tablet device. While holding the tablet device in hand, the operator can perform a management operation, such as error clearing in the money handling machine. This improves the operability of the operator.

The tablet device may transmit, to the computer, an image, an image taken by a camera of the tablet device, the image relating to the money handling machine, and the computer may process the image and generate a response based on the processing result.

For example, if the operator takes an image of the money handling machine by using the camera of the tablet device and transmits the image to the computer, the computer specifies a position where a jam has occurred in the image and provides the position to the operator. The use of image allows the operator to perform the management operation smoothly and accurately.

In a case where the instruction from the operator includes multiple instructions, the computer may generate multiple operation commands and output the operation commands to the money handling machine.

The operator can send multiple instructions to the computer at once. The burden on the operator is thus reduced.

In a case where the money handling machine executes an operation corresponding to the operation command, the money handling machine may perform a guiding operation for the operator to indicate an operation position of the money handling machine related to the management operation.

A specific example of the guiding operation to indicate the operation position of the money handling machine includes lighting of a light emitting diode (LED) at the operation position of the money handling machine, or displaying the operation position along with an illustration representing the money handling machine on the display of the money handling machine. The operator can perform the management operation accurately and promptly in response to the guiding operation.

The computer may receive, from the operator, an instruction by at least one of text input, voice input, handwriting input, or gesture input.

The operator may provide input to the computer in various forms.

The money handling machine may execute a transaction including handling of money in response to a customer operation.

The money handling machine executes a transaction including handling of money, such as a deposit transaction or a withdrawal transaction, in response to a customer operation. The operator executes a management operation different from a transaction including handling of money, such as a collection operation, a replenishment operation, or an error clearing operation.

The instruction related to the management operation may include a collection instruction which transfers a cassette storing money, which is removed from the money handling machine installed in a financial institution, to a cash center, or a replenishment instruction which attaches a cassette storing money in the cash center to the money handling machine installed in a financial institution, and the computer may perform natural language processing on the collection instruction or the replenishment instruction received, and generate an operation command corresponding to the collection instruction or the replenishment instruction received and output the operation command to the money handling machine.

The collection operation or the replenishment operation involves dispensing money from or taking money into the money handling machine. According to the above-described method, the operator can accurately instruct the money handling machine to perform the collection operation or the replenishment operation.

The instruction related to the management operation may be an error clearing instruction for the money handling machine, and the computer may perform natural language processing on the error clearing instruction received and generate an operation command corresponding to the error clearing instruction received, and output the operation command to the money handling machine.

For example, the error clearing operation may include an operation to clear a jam of money occurring during operation of the money handling machine, and may involve taking out money. If the money taken out is not correctly handled, a discrepancy may occur in the amount managed by the money handling machine. According to the above-described method, the operator can perform the error clearing operation correctly.

The present disclosure relates to a money handling system. The money handling system includes: a money handling machine that executes a process including handling of money in response to a customer operation; and a computer that assists a management operation of the money handling machine. The computer receives an instruction related to the management operation for the money handling machine from an operator, the computer performs natural language processing on the received instruction and generates an operation command corresponding to the instruction, and outputs the operation command to the money handling machine, and the money handling machine performs an operation corresponding to the operation command to execute the management operation as instructed by the operator.

Since the operator gives an instruction regarding the management operation in natural language, mistakes in operation are reduced. Further, since the use of natural language facilitates the execution of the management operation of the money handling machine, the burden on the operator is reduced.

Hereinafter, an embodiment of a method of assisting a management operation of the money handling machine and money handling system will be described with reference to the drawings. The method and system described herein are examples.

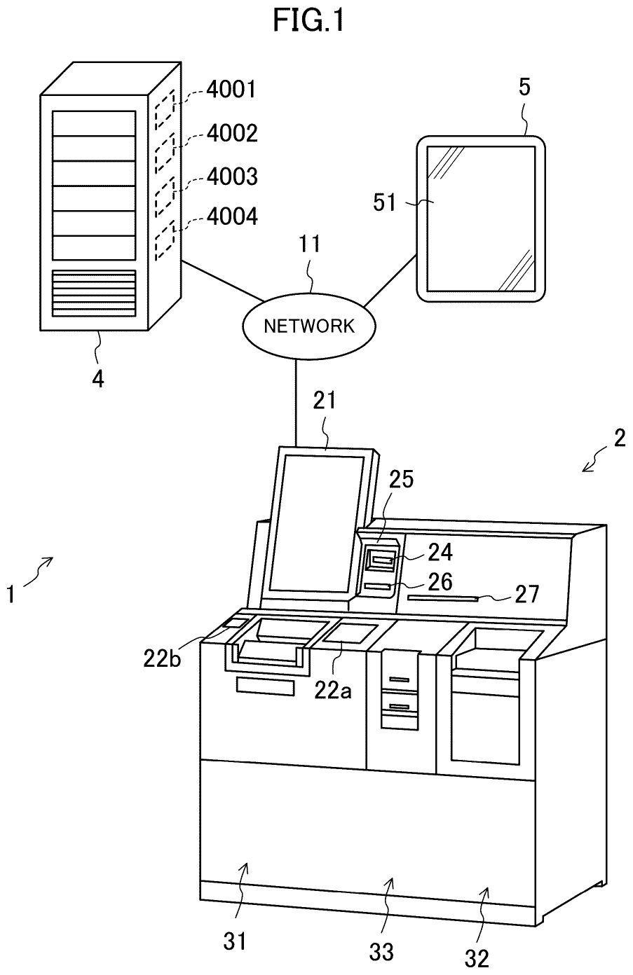

FIG. 1 shows a money handling system 1. The money handling system 1 includes a money handling machine 2. The money handling machine 2 is installed in, for example, a branch of a financial institution. The financial institution is, for example, a bank. The financial institution is not limited to a bank. A customer of the financial institutions (i.e., a user) can perform at least a deposit transaction or withdraw transaction using the money handling machine 2. The deposit transaction is a transaction of depositing money into a customer's account. During the deposit transaction, for example, the user inserts money into the money handling machine 2, and the money handling machine 2 stores the inserted money inside the money handling machine 2. The withdrawal transaction is a transaction of withdrawing money from a customer's account. During a withdrawal transaction, the money handling machine 2 dispenses an amount of money specified by the user from inside the money handling machine 2. Note that the money includes at least one of a banknote or a coin.

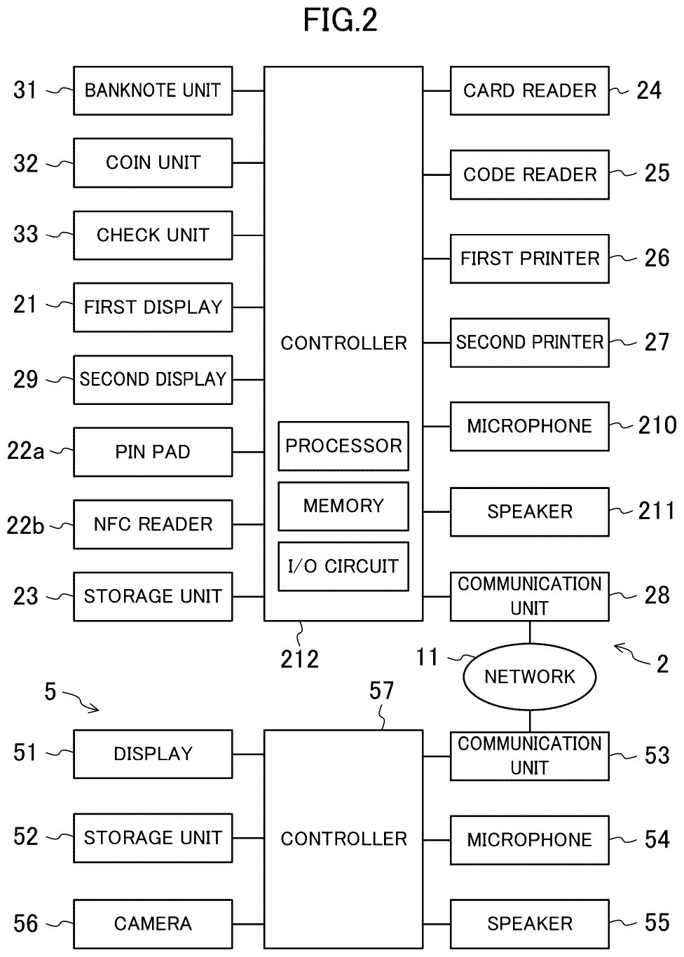

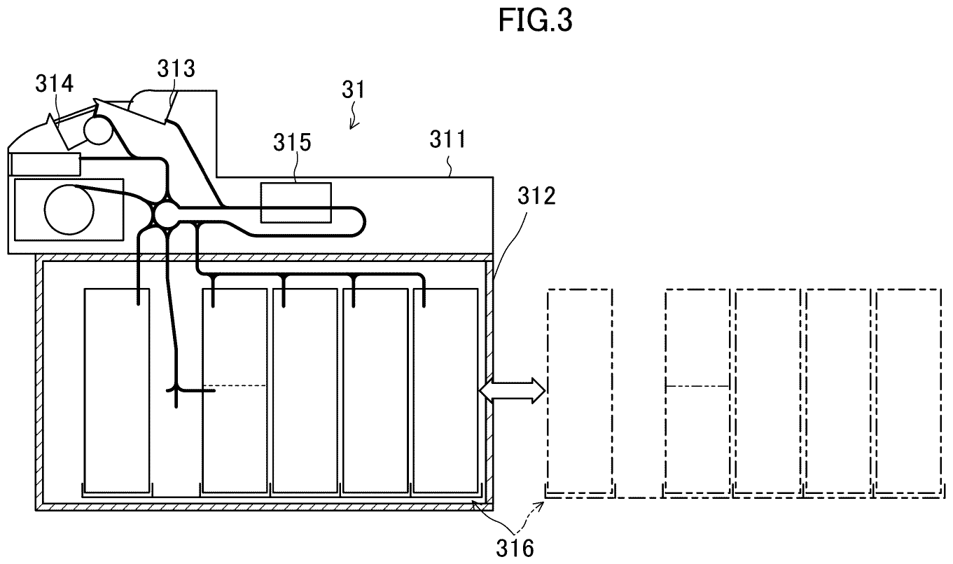

FIG. 2 is a block diagram of the money handling machine 2 and a later-described tablet device 5. As shown in FIG. 1 or 2, the money handling machine 2 includes a banknote unit 31. The banknote unit 31 processes banknotes, more precisely, loose notes. FIG. 3 shows the internal structure of the banknote unit 31. The banknote unit 31 includes a processing unit 311 and a safe unit 312. The processing unit 311 includes a deposit unit 313. The deposit unit 313 feeds banknotes into the banknote unit 31, for example, during a deposit transaction. The processing unit 311 has the dispense unit 314. The dispense unit 314 dispenses banknotes from the banknote unit 31, for example, during a withdrawal transaction. The processing unit 311 includes a recognition unit 315. The recognition unit 315 recognizes a banknote to be deposited or a banknote to be dispensed. The recognition unit 315 recognizes the banknote to obtain information such as the currency, the denomination, the serial number, the authenticity and the like. The safe unit 312 includes a container unit 316. The container unit 316 stores the deposited banknotes. The container unit 316 feeds out banknotes to be dispensed. The container unit 316 includes multiple cassettes. The cassettes store banknotes, for example, by denomination.

The money handling machine 2 includes a coin unit 32. The coin unit 32 processes coins, more precisely, loose coins. Note that the coin unit 32 may be omitted in the money handling machine 2. The money handling machine 2 includes a check unit 33. The check unit 33 processes checks. Note that the check unit 33 may be omitted in the money handling machine 2. The money handling machine 2 may be a machine that handles only banknotes, for example.

The money handling machine 2 includes a first display 21. The first display 21 provides information to a customer who operates the money handling machine 2. The first display 21 may be a touch panel display. The customer can operate the first display 21. The money handling machine 2 includes a second display 29. The second display 29 provides information to an operator who manages the money handling machine 2. The second display 29 is located, for example, on the back side of the money handling machine 2. Further, the back side of the money handling machine 2 is the side opposite to the front side of the money handling machine 2, where the first display 21 is located. The second display 29 may be a touch panel display. The operator can execute a management operation of the money handling machine 2 using the second display 29, as will be described later.

The money handling machine 2 has a personal identification number (PIN) pad 22a. The customer enters PIN information using the PIN pad 22a. The PIN information is, for example, a number, a symbol, or an alphabet.

The money handling machine 2 includes a near field communication (NFC) reader 22b. This allows contactless short-range wireless communication. User authentication and money handling may be performed using an NFC-compatible smartphone or card.

The money handling machine 2 includes a storage unit 23. The storage unit 23 stores various types of information necessary for the operation of the money handling machine 2. The storage unit 23 stores at least information on the denomination of money, the number of items of money, and the inventory amount of the money stored in each container unit of the money handling machine 2.

The money handling machine 2 includes a card reader 24. The card reader 24 reads a card of a customer, for example, a cash card. The money handling machine 2 includes a code reader 25. The code reader 25 reads a barcode or a two dimensional code.

The money handling machine 2 includes a first printer 26. The first printer 26 prints the transaction detail on a receipt. The money handling machine 2 includes a second printer 27. The second printer 27 prints the transaction detail on paper.

The money handling machine 2 includes a communication unit 28. The communication unit 28 performs communication via a network 11. The network 11 includes, for example, a local area network (LAN) and a wide area network.

The money handling machine 2 includes a microphone 210. The operator can use the microphone 210 to perform voice input to the money handling machine 2. The money handling machine 2 includes a speaker 211. The money handling machine 2 can output audio to the operator through the speaker 211.

The money handling machine 2 includes a controller 212. The controller 212 includes at least a processor, memory, and an I/O circuit. The processor executes a program. The memory stores programs and data for the operation of the money handling machine 2. The memory is, for example, a random access memory (RAM) and/or a read only memory (ROM). The I/O circuit inputs and outputs electrical signals between the controller 212 and a device connected to the controller 212. The controller 212 outputs a control signal to the device to operate the money handling machine 2.

The money handling system 1 includes a server 4. The server 4 assists the management operation of the money handling machine 2, as will be described later. The server 4 may include multiple servers. Multiple servers may have different functions. The server 4 includes at least a processor 4001, a memory 4002, a storage 4003, and a network interface 4004. The server 4 is connected to the network 11. The server 4 and the money handling machine 2 can communicate with each other via the network 11. Details of the functions of the server 4 will be described later.

The money handling system 1 includes a tablet device 5. An operator uses the tablet device 5. The tablet device 5 is a computer device, and a general-purpose tablet device can be used. The tablet device 5 is a portable device and can be operated while being separated from the money handling machine 2. As shown in FIG. 1 or 2, the tablet device 5 has a display 51. The display 51 is a touch panel display. The display 51 provides information to the operator. The operator can perform an operation using the display 51.

As shown in FIG. 2, the tablet device 5 includes a storage unit 52. The storage unit 52 stores various types of information. The tablet device 5 includes a communication unit 53. The communication unit 53 performs communication via the network 11.

The tablet device 5 includes a microphone 54. The operator can use the microphone 54 to perform voice input to the tablet device 5. The tablet device 5 includes a speaker 55. The tablet device 5 can output audio to the operator through the speaker 55. The tablet device 5 includes a camera 56. The operator can use the camera 56 to take pictures of various parts of the money handling machine 2.

### (Management Operation of Money Handling Machine)

The operator executes a management operation of the money handling machine 2. The management operation includes a collection operation. The collection operation is an operation of taking money stored in the money handling machine 2 out of the money handling machine 2. The collection operation includes multiple types of collection operations. A first collection operation is to dispense money fed out from the container unit of the money handling machine 2 to the dispense unit of the money handling machine 2. For example, the first collection operation of the banknote unit 31 is an operation of dispensing banknotes fed out from the container unit 316 to the dispense unit 314. The first collection operation is performed by, for example, a staff member of a financial institution.

A second collection operation is executed after the first collection operation. The second collection operation is to remove the cassette of the container unit of the money handling machine 2 from the money handling machine 2. For example, as virtually shown in FIG. 3, the operator can pull out the container unit 316 of the banknote unit 31 from inside the safe unit 312 to the outside, and extract the cassette from the container unit 316. The second collection operation is performed by, for example, a CIT worker. The CIT worker will transport the cassette removed from the money handling machine 2 to the cash center.

The management operation includes a replenishment operation. The replenishment operation is an operation of putting money into the container unit of the money handling machine 2. The replenishment operation includes multiple types of replenishment operations. A first replenishment operation is to store money deposited into the deposit unit of the money handling machine 2 into the storage unit of the money handling machine 2. For example, the first replenishment operation of the banknote unit 31 is an operation of storing, into the container unit 316, banknotes deposited into the deposit unit 313. The first replenishment operation is performed by, for example, a staff member of a financial institution.

A second replenishment operation is executed after the first replenishment operation. The second replenishment operation is to attach the cassette storing money to the container unit of the money handling machine 2. The second replenishment operation is performed by, for example, a CIT worker. Specifically, the CIT worker transports the cassette storing money at the cash center to the financial institution, and mounts the cassette to the money handling machine 2.

The operator executing the management operation (here, a staff member of a financial institution or a CIT worker) must accurately execute the management operation. A mistake in operation of the money handling machine 2 by the operator may lead to a discrepancy, that is, a mismatch of the amount managed by the money handling machine 2. The operator learns how to perform the management operation through a training in advance. It takes a long time for the operator to learn how to perform the operation. In particular, the CIT worker needs to operate money handling machines manufactured by different manufacturers or money handling machines of different models in various financial institutions. It takes even longer for the CIT worker to learn how to perform the management operation.

The money handling system 1 facilitates the management operation of the money handling machine 2. Specifically, the money handling system 1 enables the operator to provide an instruction regarding the management operation in natural language.

The operator inputs an instruction related to the management operation to the money handling machine 2. The input can be text input using the touch panel function of the second display 29 or voice input through the microphone 210. The operator may input a handwritten text using the touch panel function of the second display 29. The money handling machine 2 may recognize a handwritten text input and convert the handwritten text input into text. The money handling machine 2 may transmit the input handwritten text data itself to the server 4.

The operator may also input instructions related to the management operation through the tablet device 5. Such an input through the tablet device 5 can also be text input using the touch panel function of the display 51 or voice input through the microphone 54. The handwritten text may also be input using the touch panel function of display 51. The tablet device 5 may recognize an input of handwritten text and convert the input handwritten text into text. The tablet device 5 may transmit the input handwritten text data itself to the server 4. Gesture input using the camera 56 of the tablet device 5 may also be performed. The tablet device 5 may recognize gesture input and convert the input gesture into corresponding instruction. Further, the server 4 that receives an image from the tablet device 5 may recognize gesture input and convert the gesture input into corresponding instruction.

The money handling machine 2 or the tablet device 5 sends the instruction input to the server 4. The instruction input is transmitted to the server 4 in the form of text, voice, handwritten input data, or an image. The server 4 of the money handling system 1 performs natural language processing on the instruction input. The server 4 uses an artificial intelligence (AI) technology for natural language processing.

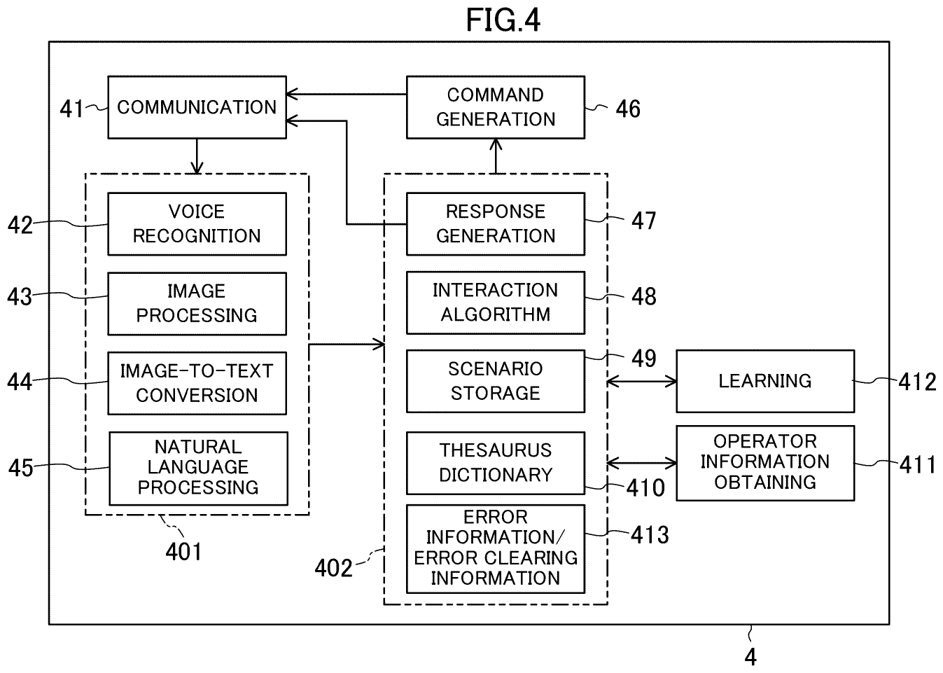

FIG. 4 is a functional block diagram showing functions of the server 4. As described above, the server 4 has a communication function 41 via the network 11. The server 4 receives an instruction from the money handling machine 2 or the tablet device 5 by using the communication function 41.

The server 4 has a voice recognition function 42. When the received instruction is voice, the server 4 recognizes the instruction using the voice recognition function 42. The server 4 has an image processing function 43. When the received instruction is an image, e.g., a handwritten text input, the server 4 uses the image processing function 43 to perform image processing on the handwritten text input so as to enable a later-described image-to-text conversion.

The server 4 has an image-to-text conversion function 44. The server 4, in response to an operator instruction, uses the image-to-text conversion function 44 as needed to convert the received instruction into text. If the received instruction is text, this conversion into text is omitted.

The server 4 has a natural language processing function 45. The server 4 uses the natural language processing function 45 to interpret the received instruction and to extract information regarding the management operation of the money handling machine 2 from the instruction given in natural language. The functions 42, 43, 44, and 45 are function 401 related to input of an operator instruction in the server 4. An algorithm for implementing the function 401 (functions 42, 43, 44, and 45) may be stored in the storage 4003 of the server 4. The processor 4001 of the server 4 executes the algorithm to implement the function 401.

The server 4 has a command generation function 46. The server 4 generates an operation command to be executed by the money handling machine 2 based on the received instruction. The operation command generated by the command generation function 46 is not a natural language but a code. The command generation function 46 is a function related to processing in the server 4 and to output to the money handling machine 2. The server 4 transmits the generated operation command to the money handling machine 2 through the network 11 by using the communication function 41. The money handling machine 2 having received the operation command in the form of code executes the management operation. An algorithm for implementing the command generation function 46 may be stored in the storage 4003 of the server 4. The processor 4001 of the server 4 executes the algorithm to implement the command generation function 46.

In the above, basic functions of the server 4 are described. The server 4 also has a function of creating a response related to an operator instruction by executing a chatbot program, that is, a response generation function 47. The response generation function 47 assists the operator in performing the management operation. The response is generated by an interaction algorithm 48. Various known algorithms can be used as the interaction algorithm 48. The functions 47 and 48 and later-described functions 49, 410, and 413 are the chatbot function 402 of the server 4. An algorithm for implementing the function 402 (functions 47 and 48, as well as functions 49, 410, and 413) may be stored in the storage 4003 of the server 4. The processor 4001 of the server 4 executes the algorithm to implement the function 402.

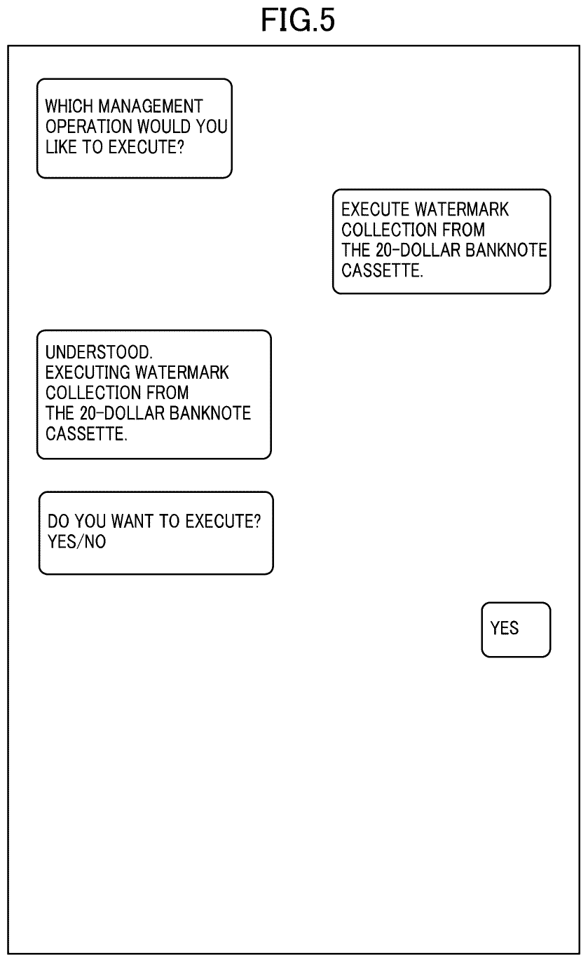

A specific example of execution of a management operation by an operator will be described with reference to FIG. 5. In this example, the operator performs the collection operation. More specifically, the operator performs an operation of collecting 20-dollar banknotes exceeding a predetermined number from a cassette storing the 20-dollar banknotes in the banknote unit 31 of the money handling machine 2, while leaving the predetermined number of 20-dollar banknotes in the cassette.

FIG. 5 illustrates a chat screen displayed on the second display 29 of the money handling machine 2 or the display 51 of the tablet device 5. When the operator performs authentication on the money handling machine 2 or the tablet device 5 and then requests execution of the management operation, the chat screen is displayed on the second display 29 or the display 51. The left side of the chat screen is a response from the server 4, whereas the right side of the chat screen is an instruction or utterance from the operator. The operator can give an instruction or make an utterance by text input, voice input, handwritten text input, or gesture input, as described above. When the operator performs voice input, the response from the server 4 is output by voice through the speaker 211 or the speaker 55.

In response to a request to execute the management operation, the server 4 responds with “Which management operation would you like to execute?” Receiving this response, the operator inputs an instruction. In the example of FIG. 5, the operator has input “Execute watermark collection from the 20-dollar banknote cassette.” The operator can use natural language for the input. The operator instruction includes: (1) that the management operation is a collection operation; (2) that the collection target is a cassette storing 20-dollar banknotes; and (3) that the amount to be collected is a watermark collection. Here, the watermark collection means collecting money exceeding the above-described predetermined number of sheets (that is, the watermark) by dispensing the money to the dispense unit 314 while leaving the predetermined number of sheets in the cassette. The server 4 interprets the instruction from the operator and determines whether an operation command can be generated with reference to the information of the storage unit 23. Here, it is assumed that the cassette storing 20-dollar banknotes is determined to exist based on the information of the storage unit 23. It is further assumed that the operator instruction includes all of the conditions (1) to (3) necessary for execution of the management operation. It is further assumed that the server 4 can generate an operation command corresponding to the operator instruction. The server 4 responds, via the response generation function 47, “Understood. Executing watermark collection from the 20-dollar banknote cassette.”

The server 4 also confirms the start of the operation by asking the operator, “Do you want to execute?” In response to the operator entering “Yes” to indicate consent, the server 4 transmits the generated operation command to the money handling machine 2. The money handling machine 2, upon receiving the operation command, performs watermark collection from the 20-dollar banknote cassette.

In the money handling system 1, the operator can give an instruction regarding a management operation in a natural language. Mistakes in operation by the operator are reduced. Further, since the management operation of the money handling machine 2 is facilitated by the use of natural language, the operator can more easily learn the operation related to the management operation.

Further, the money handling system 1 conducts bidirectional interaction with the operator using a chatbot. The server 4 can accurately recognize instructions from the operator. This makes it possible to suppress the money handling machine 2 from performing an operation that deviates from the operator's intention due to mistakes in operation.

Further, since the content of the operation command is presented to the operator before the server 4 outputs the operation command to the money handling machine 2, the operator can confirm the detail of the operation command. When the operator consents, the server 4 outputs the operation command to the money handling machine 2, and thus the money handling machine 2 is suppressed from performing an operation that deviates from the operator's intention. Note that an example is described hereinabove, where the server 4 generates an appropriate operation command (“Understood. Executing watermark collection from the 20-dollar banknote cassette.”) in response to the operator instruction (“Execute watermark collection of the 20-dollar banknote cassette.”). If the server 4 does not generate an appropriate operation command in response to the operator instruction, the operator can provide input in natural language again in response to the confirmation from the server 4 (“Do you want to execute?”), and the server 4 generates an operation command based on the renewed input in natural language.

In the chatbot, the server 4 responds, “Executing watermark collection,” using the expression “watermark collection” as used by the operator. The operator can accurately understand the response from the server 4.

Since the operator in the aforementioned example is an expert, the operator is able to provide an instruction including all of the conditions (1) to (3) necessary for execution of the management operation at once. In contrast, it may be difficult for a beginner operator to complete an instruction all at once. The money handling system 1 guides the beginner operator, so that the operator can give an accurate instruction using the chatbot.

As mentioned above, the operator performs authentication before initiating the management operation. The server 4 has a function 411 that obtains information on the operator from authentication information. Specifically, the server 4 may authenticate (identify) the operator based on identification information of the operator input to the second display 29. Where the information of the operator is stored is not particularly limited. The information of the operator includes, for example, history information (work experience, job skill, the number of years of continuous work, and the like) of the operator. The server 4 may determine whether the operator is a beginner or an expert from the history information. The information on the operator may include an operation level. The operation level relates to an ability to execute the management operation, and the operation level of an expert is relatively high, whereas the operation level of a beginner is relatively low.

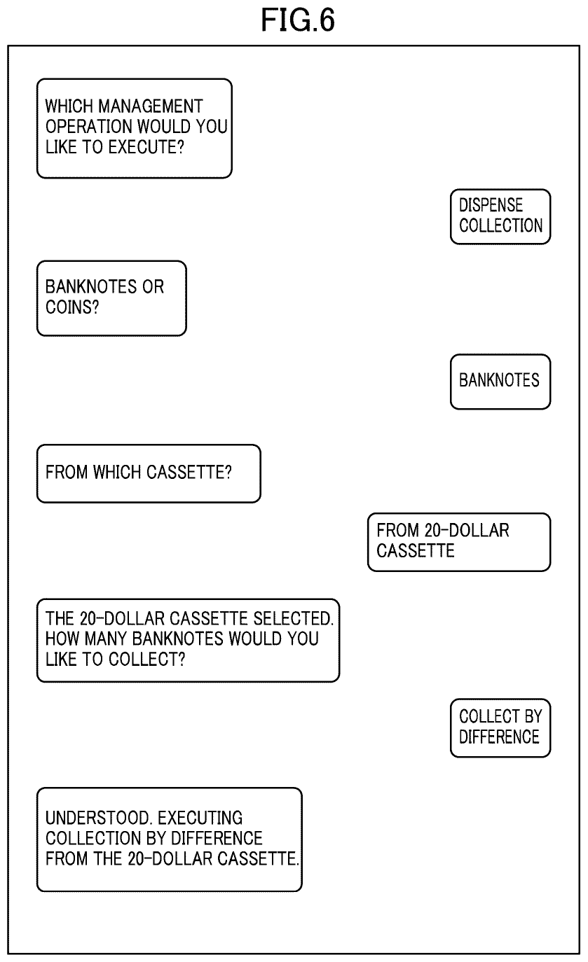

FIG. 6 shows a chat screen in a case where the operator is a beginner. Similar to the chat screen in FIG. 5, the server 4 responds with “Which management operation would you like to execute?” In response to this, the operator inputs “dispense collection.” While this operator instruction designates a process of dispensing money fed out from a cassette to the dispense unit, it does not include conditions related to the cassette to be collected and the amount to be collected. As shown in FIG. 4, the server 4 stores a scenario used for the chatbot (i.e., a scenario storage function 49). The scenario includes a scenario in which the operator is a beginner operator. The server 4 generates a response for the operator based on the operator's information and the scenarios stored therein. In response to the operator input “dispense collection,” the message “Banknotes or coins?” is displayed on the chat screen.

In response to the response from the server 4, the operator inputs “banknotes.” The server 4 responds to this instruction with “From which cassette?” according to the scenario. The operator then enters “From 20-dollar cassette.” Through the interaction between the server 4 and the operator up to this point, it is specified that the dispense collection targets the cassette storing the 20-dollar banknotes. Note that the server 4 confirms the existence of the cassette storing 20-dollar banknotes by referring to the information of storage unit 23. If there is no cassette storing the 20-dollar banknotes, the server 4 prompts the operator to designate another cassette.

The server 4 further responds, “From the 20-dollar cassette selected. How many banknotes would you like to collect?” By including the “20-dollar cassette” entered by the operator in the response, the server 4 can confirm the intention of the operator.

In response to the message from the server 4, the operator inputs “collect by difference.” Here, the collection by difference means feeding out, from the cassette, the number of money corresponding to the difference between the number of items of money currently stored in the cassette and the preset number, and collecting the same. That is, the collection by difference is a synonym of the above-described watermark collection. The server 4 includes a thesaurus dictionary 410. The thesaurus dictionary 410 includes synonyms such as the aforementioned collection by difference and watermark collection, or wording with similar meanings. The thesaurus dictionary 410 may store in-house terms. The server 4 uses the thesaurus dictionary 410 in the chatbot to handle different wording having the same meaning.

The server 4 responds, “Understood. Executing collection by difference from the 20-dollar cassette.” This response has the same meaning as “Understood. Executing watermark collection from the 20-dollar banknote cassette.” on the chat screen in FIG. 5, and the money handling machine 2 will perform the same operation in both cases. In the chatbot, the server 4 responds, “Executing collection by difference” using the expression “collection by difference” as used by the operator. When the operator is a beginner, it is easier for the operator to confirm that the intended operation is being executed. Further, an in-house term used in an organization and an institution to which the operator belongs may be used for the response from the server 4.

Even if there are insufficient conditions for creating the operation command, the money handling system 1 outputs, via the chatbot, a response to the operator that prompts the operator to provide the missing information for creating the operation command. The server 4 analyzes the received operator input and determines whether or not the input information is insufficient for creating the operation command. When the input information is insufficient for creating the operation command, the server 4 outputs a response to the operator to prompt the operator to provide information necessary for creating the operation command.

The response prompting the operator to provide information is, for example, a response such as “From which cassette?” or “How many banknotes would you like to collect?” Through the interaction by the chatbot, the operator can add the missing information. The server 4 can generate an operation command that matches the intention of the operator.

Further, the server 4 obtains information on the operator based on the operator's authentication and executes the chatbot program based on the information on the operator. The server 4 generates a response according to the operation level of the operator. As shown in FIG. 5 or 6, the server 4 can carry out an appropriate interaction with each of the expert and the beginner. Since the response of the chatbot changes according to the operation level of the operator, both an expert and beginner can smoothly and accurately execute the management operation.

For example, when the server 4 determines that the operation level of the operator is low, the server 4 may present, to the operator, options of management operations that can be selected by the operator, instead of the response “Which management operation would you like to execute?” in FIG. 6. By presenting options, the operator can correctly specify the desirable management operation. The server 4 may set options to be presented to the operator by referring to the information in the storage unit 23.

Further, since the server 4 has the thesaurus dictionary 410, even if various operators input instructions related to the management operation using different terms, the server 4 can accurately recognize the instructions specified by the operators. Mistakes in operation by the operator is reduced. Further, the operator can avoid the need to use different terms depending on the money handling machine 2.

Here, the server 4 improves the interaction algorithm 48, the stored scenarios, and the thesaurus dictionary 410 by a learning function 412. An algorithm for implementing the learning function 412 may be stored in the storage 4003 of the server 4. The processor 4001 of the server 4 executes the algorithm to implement the learning function 412.

Note that the server 4 generates a response to a beginner operator based on a scenario, but may also generate a response based on a pre-learned model or using real-time data without using a scenario.

The aforementioned example is one in which a staff member of a financial institution acts as an operator to implement a management operation of the money handling machine 2.

The same applies to the case where a CIT worker conducts a management operation of the money handling machine 2 as an operator.

### (Assistance in Error Clearing Operation)

The management operation performed by the operator includes error clearing in the money handling machine 2. The error clearing may include clearing a jam of money that occurred during the operation of the money handling machine 2. The operator can also give an instruction related to error clearing by using natural language. The server 4 may perform natural language processing on the error clearing instruction received and generate an operation command corresponding to the error clearing instruction received, and output the operation command to the money handling machine 2.

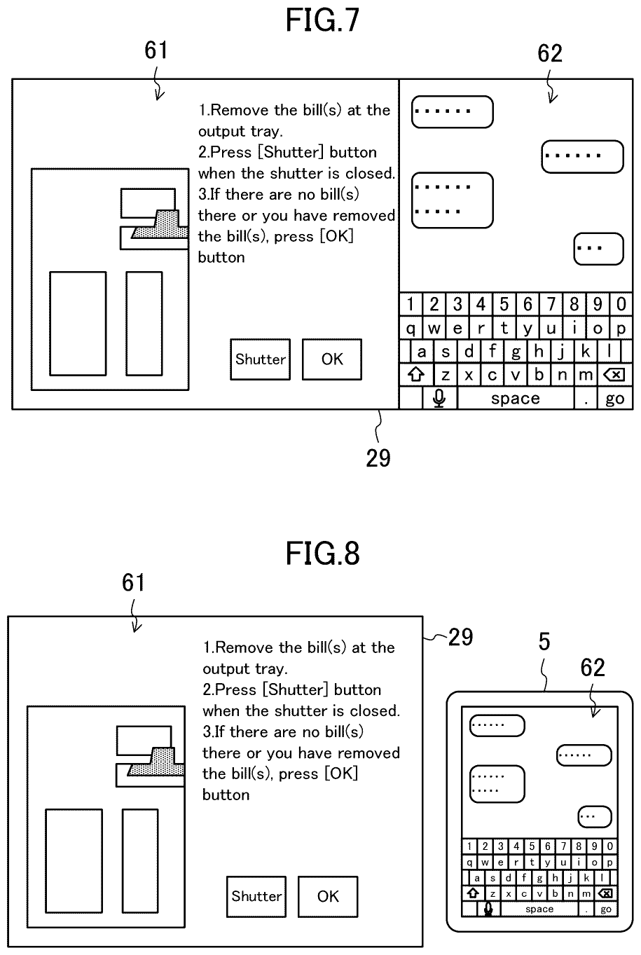

FIG. 7 illustrates a screen displayed on the second display 29 of the money handling machine 2 during the management operation for error clearing. The second display 29 simultaneously displays an error clearing-related screen 61 and the chat screen 62. The error clearing-related screen 61 is a screen prepared in advance in the money handling machine 2. The error clearing-related screen 61 is stored in the money handling machine 2 in association with an error code. The money handling machine 2, when an error occurs, identifies an error code and displays the screen 61 corresponding to the identified error code on the second display 29. The operator executes error clearing by following the instructed procedures while referring to the error clearing-related screen 61.

During the management operation for error clearing, the money handling system 1 uses the chatbot in the same manner as described above. The use of the chatbot makes it possible to guide the operator to perform error clearing through the correct procedures. It is expected that error clearing will be performed through the correct procedures, and that the work efficiency of the operator will be improved.

For example, if the operator does not know what to do next at the start or in the middle of error clearing, the operator inputs that situation in the chat screen 62. As mentioned above, the input includes text input, voice input, handwriting input, or gesture input.

As shown in FIG. 4, the server 4 stores error information/error clearing information 413. The error information/error clearing information 413 also includes the error code described above. The server 4 refers to the error information/error clearing information 413 and responds with the operation that the operator should perform next regarding the clearing of the error occurred.

Further, if the operator does not know how to handle the money taken out from the money handling machine 2 in the process of clearing an error that occurred during a withdrawal transaction of the money handling machine 2, the operator inputs that situation in the chat screen 62. For example, when the serial numbers of banknotes have been read, the server 4 refers to the log of the money handling machine 2 and displays, on the chat screen 62, the serial numbers of banknotes that are regarded as already dispensed. By matching the serial numbers displayed on the chat screen 62 with the serial numbers of the banknotes in hand, the operator can distinguish between banknotes that have already been dispensed and do not need to be put back into the money handling machine 2, and banknotes that have not been dispensed and need to be put back into the money handling machine 2.

If the operator does not know where the money is jammed in the money handling machine 2, the operator inputs that situation in the chat screen 62. The server 4 displays, for example in the form of an animation, the location where the money jam has occurred on the error clearing-related screen 61, based on information from the money handling machine 2. The server 4 also prompts the operator to use the camera 56 of the tablet device 5 to take a picture of the inside of the money handling machine 2 through the chat screen 62. The server 4 transmits information on the location where the money jam has occurred to the tablet device 5, and the tablet device 5 overlays the location where the money jam has occurred on the image captured by the camera 56, using, for example, augmented reality (AR). The operator can easily recognize the location where the money jam has occurred by looking at the image displayed on the tablet device 5.

Further, if the operator does not understand the content of the error clearing-related screen 61 that is displayed when an error occurs in the money handling machine 2, the operator inputs that situation in the chat screen 62. The operator can copy the wording from the error clearing-related screen 61 and paste it into chat screen 62. The server 4 converts the content of the screen 61 into an expression that is easier to understand, and displays it on the chat screen 62. The conversion of the expression can be realized by using the AI technology.

The operator can also enter a query for past, similar error cases in the chat screen 62. The server 4 refers to the error information/error clearing information 413 and provides the past, similar error information to the operator. The operator can perform the error clearing operation by referring to the past error information.

By combining the error clearing operation with the chatbot, the operator can obtain information that is not included in the default screen 61 through interaction with the server 4. This improves the efficiency of the error clearing operation by the operator and achieves an accurate error clearing operation. The manufacturer of the money handling machine 2 can prepare the error clearing-related screen 61 on the premise of assistance by the chatbot.

As shown in FIG. 7, when both the management operation-related screen 61 and the chat screen 62 are displayed on a single display, the operator can execute the management operation while viewing both the management operation-related screen 61 and the chat screen 62. Further, since both the management operation-related screen 61 and the chat screen 62 are displayed on a single display, the wording on the management operation-related screen 61 can be copied and pasted into the chat screen 62. This improves the operability of the operator.

If the server 4 determines, by analyzing the information input by the operator on the chat screen 62, that it is necessary to change the management operation-related screen 61, it may change the management operation-related screen 61 in response to the operator input. The server 4 may change the management operation-related screen 61 in synchronization with the operator input.

FIG. 8 shows a variation. The second display 29 of the money handling machine 2 may display the management operation-related screen 61, and the tablet device 5 may display the chat screen 62. While holding the tablet device 5, the operator can perform an error clearing operation for the money handling machine 2. The work efficiency of the operator will increase. Further, using the tablet device 5 also provides the advantage that the operator can more easily perform voice input during the error clearing operation.

Further, the second display 29 of the money handling machine 2 may display the chat screen 62, and the tablet device 5 may display the management operation-related screen 61.

Here, in the error clearing operation, the money handling machine 2 may perform a guiding operation to indicate the location to be operated by the operator, in response to an input from the operator to the chatbot. Examples of the guiding operation include indicating the position to be operated on the money handling machine 2 by lighting an LED, or displaying the position to be operated along with an illustration representing the money handling machine 2 on the second display 29 or the tablet device 5. The operator can perform management operations accurately and promptly in response to the guiding operation.

### (Processing Procedure of Server 4)

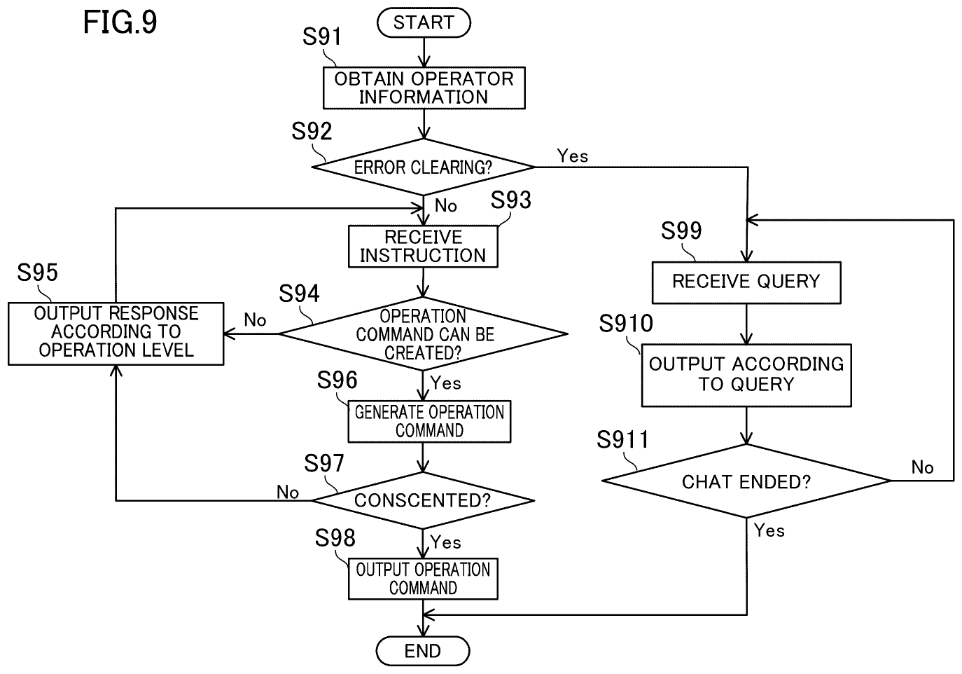

FIG. 9 is a flowchart related to the process of the server 4. The flow in FIG. 9 starts when the operator performing the management operation conducts authentication on the money handling machine 2 or the tablet device 5. The server 4 first obtains the information of the authenticated operator in Step S91. The server 4 determines whether the operator is a beginner or an expert.

Subsequently, in Step S92, the server 4 determines whether the operation is an error clearing operation. If it is not error clearing, the operator is inputting instructions for the processing to be executed by the money handling machine 2. The server accepts the operator instructions in Step S93. In Step S94, the server 4 refers to the information in the storage unit 23 as mentioned above and determines whether an operation command for the money handling machine 2 can be generated based on the instruction received in Step S93. If an operation command cannot be generated, that is, if the instruction from the operator alone results in insufficient conditions or if there is an inaccuracy in the instruction from the operator, the server 4 outputs a response of the chatbot in Step S95. The server responds according to the operation level of the operator based on the information obtained in Step S91. In the chatbot, when there is a response from the server 4, the operator inputs an instruction in response to that server response. In Step S93, the server 4 again accepts the instruction, and in Step S94, determines whether an operation command can be generated. The interaction between the operator and the server 4 in the chatbot will continue until the operation command can be generated.

In Step S94, if it is determined that an operation command can be generated, the server 4 generates an operation command corresponding to the instruction from the operator in Step S96, and in Step S97, determines whether consent has been obtained from the operator for the generated operation command. If no consent is given, the server 4 outputs a response of the chatbot in Step S95. When the operator gives an instruction in response to the chatbot response, a new operation command is generated in Step S96.

In Step S97, if consent from the operator is obtained, the server 4 outputs the generated operation command to the money handling machine 2 in Step S98. The money handling machine 2 receives the operation command from the server 4 and executes the operation related to the management operation.

When the operator requests error clearing in Step S92, the server 4 identifies the error code and, in Step S99, receives the query input by the operator on the chat screen. In Step S910, the server 4 outputs a response corresponding to the received inquiry. The output in Step S910 includes not only a response on the chat screen by the server 4, but also an output for operating the money handling machine 2, such as lighting a specific location of the money handling machine 2 with an LED.

In step S911, the server 4 determines whether the chat has ended, and if the chat has not yet ended, Steps S99 and S910 are repeated. If the chat is completed, the process in FIG. 9 ends.

### Variation

In the above-described money handling system 1, the server 4 executes the natural language processing. However, the money handling machine 2 or the tablet device 5, which receives an input from the operator, may alternatively execute the natural language processing on the operator input.

Further, when the instruction from the operator includes multiple instructions, the server 4 may generate multiple operation commands and output them to the money handling machine 2. For example, when the operator replenishes the money handling machine 2 with money and causes the money handling machine 2 to execute reconciliation processing to confirm the inventory amount of the cassette after the replenishment, the operator may input both the execution of the replenishment processing and the reconciliation processing after the replenishment. The money handling machine sequentially executes multiple processes based on multiple operation commands generated by the server 4.

The functions of the elements disclosed herein may be implemented using circuitry or processing circuitry including general purpose processors, special purpose processors, integrated circuits, application specific integrated circuits (ASICs), traditional circuitry, and/or combinations thereof configured or programmed to perform the disclosed functions. The processor is regarded as a processing circuit or circuitry because it includes transistors and other circuits therein. The processor may be a programmed processor that executes a program stored in a memory. In the present disclosure, a circuit, unit, or means is hardware that performs or is programmed to perform the functions recited. The hardware may be hardware disclosed in the present specification or other known hardware. In the case of a processor, which is considered a type of circuit, the circuit, means, or unit is a combination of hardware and software, and the software is used to configure the hardware and/or the processor.

What is claimed is:

1. A method of assisting a management operation of a money handling machine, the method comprising:
receiving, by a computer, an instruction related to the management operation for a money handling machine from an operator;
performing, by the computer, natural language processing on the received instruction, generating an operation command corresponding to the instruction, and outputting the operation command to the money handling machine; and
performing, by the money handling machine, an operation corresponding to the operation command to execute the management operation as instructed by the operator.

2. The method of claim 1, further comprising:
generating, by the computer, a response related to the received instruction by executing a chatbot program as the natural language processing; and
outputting, by the computer, the response to the operator.

3. The method of claim 2, further comprising:
generating, by the computer, the response by using an expression that corresponds to an expression contained in the instruction from the operator.

4. The method of claim 2, further comprising:
before outputting the operation command, generating, by the computer, a response that includes a content of the operation command and confirms consent by the operator, and outputs the response to the operator; and
outputting, by the computer, the operation command to the money handling machine after receiving the consent from the operator.

5. The method of claim 2, further comprising:
obtaining, by the computer, information on the operator based on authentication of the operator; and
executing, by the computer, the chatbot program based on the information on the operator.

6. The method of claim 5, further comprising:
generating, by the computer, a response according to an operation level of the operator.

7. The method of claim 2, further comprising:
outputting, by the computer, to the operator, a response that prompts the operator to provide information that is insufficient for creating the operation command.

8. The method of claim 2, further comprising:
displaying, by the money handling machine, on a display, a screen related to the management operation and a chat screen accompanying the execution of the chatbot program.

9. The method of claim 2, further comprising:
displaying, by the money handling machine, on a display, a screen related to the management operation; and
displaying, by a tablet device, a chat screen accompanying the execution of the chatbot program.

10. The method of claim 9, further comprising:
transmitting, by the tablet device, to the computer, an image taken by a camera of the tablet device, the image relating to the money handling machine; and
processing, by the computer, the image and generating, by the computer, a response based on a processing result.

11. The method of claim 1, further comprising:
in a case where the instruction from the operator includes multiple instructions, generating, by the computer, multiple operation commands and outputting, by the computer, the operation commands to the money handling machine.

12. The method of claim 1, further comprising:
in a case where the money handling machine executes an operation corresponding to the operation command, performing, by the money handling machine, a guiding operation for the operator to indicate an operation position of the money handling machine related to the management operation.

13. The method of claim 1, further comprising:
receiving, by the computer, from the operator, an instruction by at least one of text input, voice input, handwriting input, or gesture input.

14. The method of claim 1, further comprising:
executing, the money handling machine, a transaction including handling of money in response to a customer operation.

15. The method of claim 1, wherein
the instruction related to the management operation includes a collection instruction that transfers a cassette storing money and being removed from the money handling machine installed in a financial institution, to a cash center, or a replenishment instruction that attaches a cassette storing money in the cash center to the money handling machine installed in a financial institution, the method further comprising:
performing, by the computer, the natural language processing on the collection instruction or the replenishment instruction received;
generating, by the computer, an operation command corresponding to the collection instruction or the replenishment instruction received; and
outputting, by the computer, the operation command to the money handling machine.

16. The method of claim 1, wherein
the instruction related to the management operation is an error clearing instruction for the money handling machine, the method further comprising:
performing, by the computer, the natural language processing on the error clearing instruction received;
generating, by the computer, an operation command corresponding to the error clearing instruction received; and
outputting, by the computer, the operation command to the money handling machine.

17. A money handling system, comprising:
a money handling machine that executes a process including handling of money in response to a customer operation; and
a computer that assists a management operation of the money handling machine, wherein
the computer receives an instruction related to the management operation for the money handling machine from an operator,
the computer performs natural language processing on the received instruction, generates an operation command corresponding to the instruction, and outputs the operation command to the money handling machine, and
the money handling machine performs an operation corresponding to the operation command to execute the management operation as instructed by the operator.
